(19) United States
(12) Patent Application Publication
(10) Pub. No.: US 2016/0293145 A1
(43) Pub. Date: Oct. 6, 2016

(54) Single Bolt Guitar Neck Attachment

(71) Applicant: Fender Musical Instruments Corporation, Scottsdale, AZ (US)

(72) Inventors: Keith L. Chapman, Fountain Hills, AZ (US); Christopher W. Baldwin, Mesa, AZ (US); Ron Derek G. Dema-Ala, Scottsdale, AZ (US)

(73) Assignee: FENDER MUSICAL INSTRUMENTS CORPORATION, Scottsdale, AZ (US)

(21) Appl. No.: 14/677,617

(22) Filed: Apr. 2, 2015

(51) Int. Cl. G10D 3/06

(52) U.S. Cl. CPC G10D 3/06

(57) ABSTRACT

A musical instrument has a body. A first shoulder pin is press fit into a first recess of the body. A second shoulder pin is press fit into a third recess of the body. The musical instrument has a neck. A neck plate is attached to the neck with countersunk screws. A surface of the neck plate is coplanar with a surface of the neck. The neck includes a reinforcing ridge on a surface of the neck plate. The neck is disposed in a cavity of the body and around the first shoulder pin and second shoulder pin. A rear plate is disposed in a recess of the body. A bolt is disposed through the body and rear plate. The bolt is attached to the neck through the neck plate. Only a single bolt is used to attach the body to the neck.

### FIELD OF THE INVENTION

The present invention relates in general to musical instruments and, more particularly, to a single bolt guitar neck attachment.

### BACKGROUND OF THE INVENTION

Musical instruments have always been popular in society providing entertainment, social interaction, self-expression, and a source of livelihood for many people. Musical instruments and related accessories are used by professional and amateur musicians to generate, alter, transmit, and reproduce audio signals. The audio signal from the musical instrument is typically an analog signal containing a progression of values within a continuous range. The audio signal can also be digital in nature, containing a series of binary one and zero values.

Guitars are one type of musical instrument used by both amateur and professional musicians. A guitar is played by displacing one or more of the tightly strung strings from a neutral position, causing the string to vibrate as the string returns to the neutral position. In the case of an electric guitar, pickups are attached beneath the guitar strings to generate or modulate an electrical signal in response to the movement of the strings. The electrical signals are routed from the guitar to external equipment, for example, an amplifier and speaker for reproduction of the sound corresponding to the vibrating strings, or a computer system for digital storage of the audio signal.

Many musicians are do-it-yourselfers who enjoy tinkering with their musical instruments to achieve unique sound qualities. Guitar players are able to change the strings of their guitars, replace or modify the guitar's pickups, or perform modifications to the body or neck, to achieve a desired sound of the guitar. Guitar players may find a needed guitar repair can be done at home, possibly by following an online tutorial or with the help of a more knowledgeable friend, if not based solely on past experience. One or more of the guitar pickups may need replaced if the pickup coil is an open circuit, a string may need to be replaced after being broken, or a loose nut may need to be reglued.

Many of the modifications or repairs guitar players desire to perform require removal of the neck of a guitar. A shim can be inserted between the body and neck of a guitar to correct the angle of the neck relative to the body. A neck may need replaced due to wear of the frets or bowing that occurs over time due to the tension of the strings. A neck could also be replaced with a neck made from a different material for a different playing style or sound. A neck may need to be temporarily removed to access electronics under the pickguard.

In any case, many of the adjustments or repairs that musicians make to guitars require removal and subsequent reattachment of the neck of the guitar. Many prior art guitars use four wood screws extending through the body of the guitar to hold the neck onto the body. Threads of the wood screws grip into the wood neck of the guitar, and hold the neck against the body when tightened. The long wood screws required to extend through the body of the guitar and into the neck provide leverage against the neck when forces are applied. The leverage of the longer screws can result in the wood screws being pulled out of the neck. Having to remove wood screws from the neck, and replace the screws into the wood portion of the neck, each time the neck is removed risks overtightening the screws and stripping the screw holes in the neck. Moreover, the work of removing and then reinstalling all four wood screws prevents quickly and easily removing a neck when needed.

### SUMMARY OF THE INVENTION

A need exists to allow a musician to quickly and easily remove and attach a neck to a body of a guitar. Accordingly, in one embodiment, the present invention is a method of making a musical instrument comprising the steps of providing a body, disposing a shoulder pin in a cavity of the body, disposing a neck in the cavity of the body and around the shoulder pin, and disposing a bolt through the body and into an opening on the neck.

In another embodiment, the present invention is a method of making a musical instrument comprising the steps of providing a body, disposing a pin in a cavity of the body, and disposing a neck in the cavity of the body and around the pin.

In another embodiment, the present invention is a musical instrument comprising a body and a neck. A first pin is disposed in a first recess of the body and a second recess of the neck. A second pin is disposed in a third recess of the body and a fourth recess of the neck.

In another embodiment, the present invention is a musical instrument comprising a body and a neck. A first pin is disposed between the neck and body.

### BRIEF DESCRIPTION OF THE DRAWINGS

FIG. 1 illustrates a guitar including a detachable neck;

FIGS. 2a-2c illustrate the connection point between a neck and body of a guitar;

FIGS. 3a-3b illustrate a bolt used to attach the guitar neck to the guitar body;

FIGS. 4a-4b illustrate a rear plate used in the neck attachment mechanism;

FIGS. 5a-5b illustrate the body of the guitar;

FIGS. 6a-6b illustrate a shoulder pin for aligning the guitar neck and body;

FIGS. 7a-7c illustrate the portion of the neck that mates with the guitar body;

FIGS. 8a-8b illustrate a neck plate used to hold the neck to the body of the guitar; and

FIG. 9 illustrates the parts of the guitar in an exploded view.

### DETAILED DESCRIPTION OF THE DRAWINGS

The present invention is described in one or more embodiments in the following description with reference to the figures, in which like numerals represent the same or similar elements. While the invention is described in terms of the best mode for achieving objectives of the invention, those skilled in the art will appreciate that the disclosure is intended to cover alternatives, modifications, and equivalents as may be included within the spirit and scope of the invention as defined by the appended claims and claims equivalents as supported by the following disclosure and drawings.

Guitar playing involves displacing one or more tightly strung strings from a neutral position, causing the string to vibrate as the string returns to the neutral position. An electric guitar employs electromagnetic pickups and amplifiers to produce sound. The pickups are attached to the guitar and generate or modulate an electrical signal in response to the movement of the strings. The electrical signals extend over a range or spectrum of frequencies with an amplitude associated with each frequency component. Various signal processing and conditioning are typically performed on the audio signal. The audio signal from the guitar is transmitted through onboard equipment, e.g., pickups and internal circuitry, and through external accessories, e.g., amplifiers, speakers, mixers, synthesizers, effects pedals, and samplers, for signal processing and sound reproduction. The signal processing includes amplification, filtering, equalization, addition of sound effects, user-defined modules, and other signal processing functions, which adjust the power level and enhance properties of the audio signal.

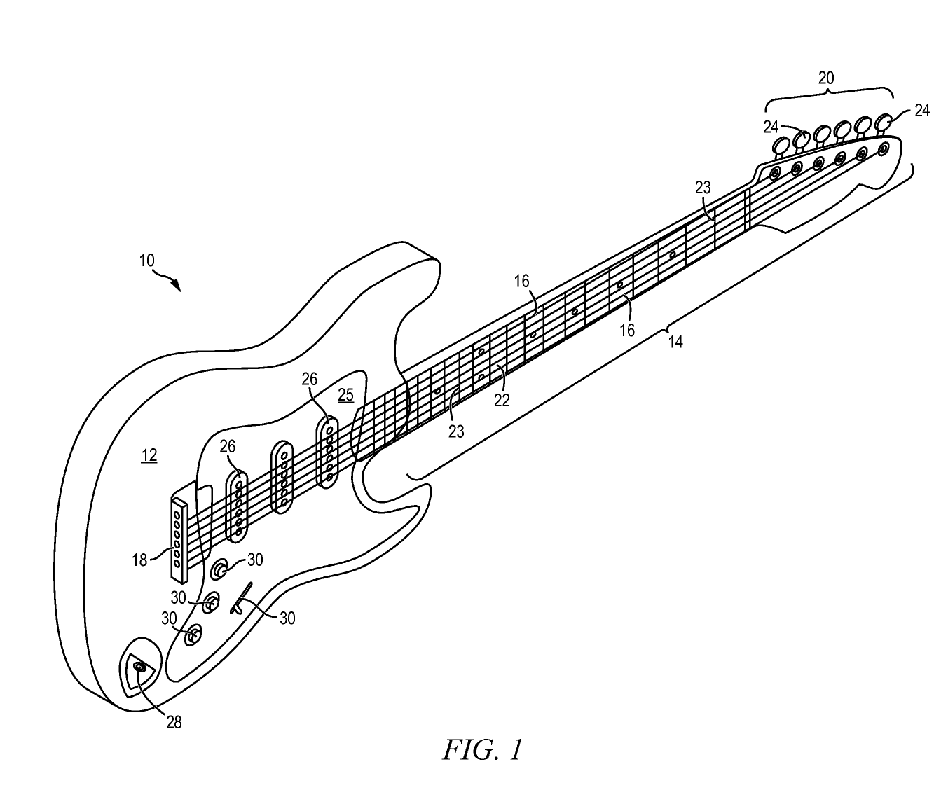

FIG. 1 shows an electric guitar 10 including body 12, neck 14, and strings 16. In other embodiments, the disclosed neck attachment is used with an acoustic guitar or other musical instrument having a neck attached to a body. A bridge 18 is affixed to body 12 using adhesive, screws, clips, or other suitable attachment mechanism. Bridge 18 anchors and supports one end of strings 16. Neck 14 of electric guitar 10 includes headstock 20 and fretboard 22. Fretboard 22 is mounted on a flat surface of neck 14 and oriented towards strings 16. Fretboard 22 spans the entire width of neck 14, and extends along the length of the neck from headstock 20 to body 12.

Fretboard 22 includes multiple frets 23 disposed periodically along the length of the fretboard. Fretboard 22 allows the effective length of a string 16 to be altered by bringing the string into contact with the fretboard or with a fret 23 incorporated in the fretboard. Altering the effective length of strings 16 alters the frequencies at which the strings vibrates when guitar 10 is played. Frets 23 are raised elements of fretboard 22. When a string 16 is pressed down over fretboard 22, the string typically contacts a fret 23 rather than the underlying fretboard. Frets 23 divide the neck into fixed segments at intervals related to a musical framework. On guitar 10, each fret represents one semitone in the standard western system where one octave is divided into twelve semitones. Pressing on a string 16 one fret closer or further away from body 12 changes the pitch of the string by one semitone, or one twelfth of an octave.

Headstock 20 includes machine heads 24 that anchor an end of strings 16 opposite bridge 18. The tension of strings 16 is adjusted by turning machine heads 24 to tune guitar 10. A pickguard or scratch plate 25 is attached to body 12. Pickguard 25 protects guitar 10 from damage or marking by a guitar pick during play. Pickguard 25 is plastic, acrylic glass, polyvinyl chloride, glass, plywood, fabric, metal, animal skin, nacre, or other suitable protective material. Pickguard 25 is mounted to body 12 using adhesive, screws, clips, or other suitable attachment mechanism. Pickguard 25 can be cut or molded to any shape to be both functional and aesthetic. The internal circuitry and other functional aspects of guitar 10 can be accessed by removing pickguard 25.

Pickups 26 are mounted to body 12 using adhesive, screws, clips, or other suitable attachment mechanism. Pickups 26 are disposed under strings 16. Pickups 26 convert string movement to electrical signals with the same frequency as the string movement, representative of the intended sounds from the vibrating strings. An audio output jack 28 is affixed to body 12. The electrical signals generated by pickups 26 are combined into a single signal and output from guitar 10 through audio output jack 28. In other embodiments, the audio signal generated by guitar 10 is output through another type of jack, or output digitally through a Universal Serial Bus (USB) port, TOSLINK connector, or to a computer network through an RJ45 port or Wi-Fi connection. Other output ports and other output data formats are used in other embodiments. In some embodiments, control data is sent from or to guitar 10 via output jack 28 in addition to the audio signal being output.

Controls 30 are used by a musician to control the sound output from output jack 28. Controls 30 include a switch or knob to control which of the multiple pickups 26 are connected to generate an audio signal to output jack 28. Guitar 10 is capable of routing the audio from any single pickup 26 to output jack 28, or combines the audio from multiple pickups 26 into a single audio signal for output to jack 28. Each pickup 26 offers slightly different sound qualities based on the unique location and other properties of the pickup. Controls 30 include a knob for controlling the volume of the audio signal output to jack 28. A potentiometer connected to a knob of controls 30 attenuates the audio signal to a volume level desired by a musician and controlled by turning the knob of the controls. Controls 30 include a knob, slider, or switch to control one or more sound effects applied to the audio signal from pickups 26 prior to the signal being output to jack 28. Guitar 10 can add reverb, vibrato, wah, echo, distortion, or other sound modifications to the generated audio signal using built-in modules. In other embodiments, other control mechanisms are included on guitar 10, such as a touch sensitive input or toggle buttons.

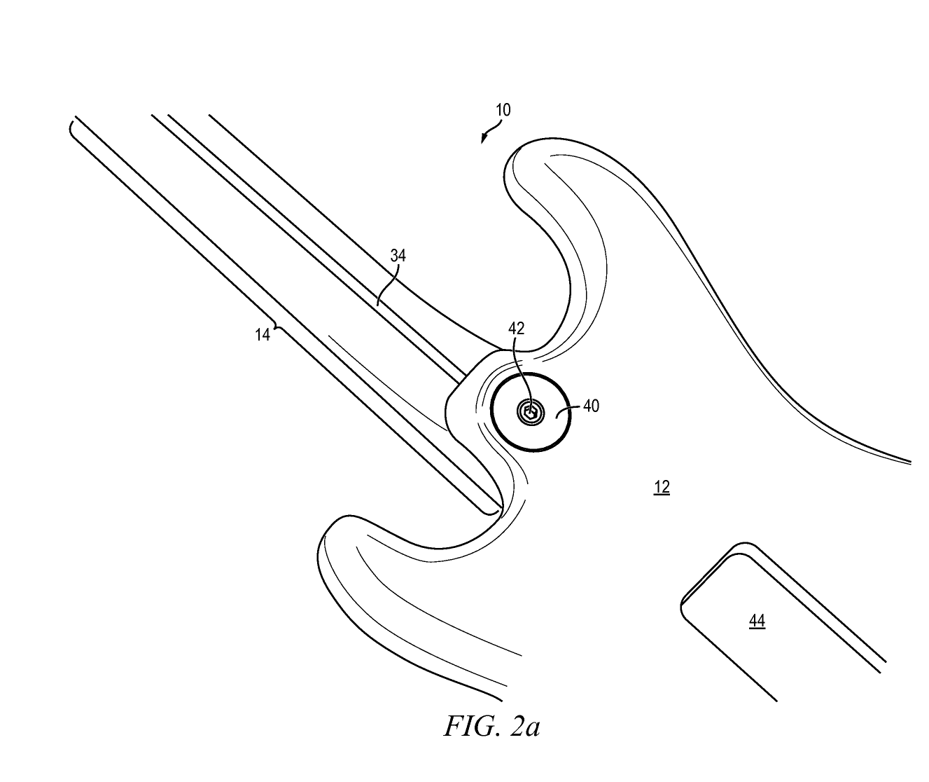

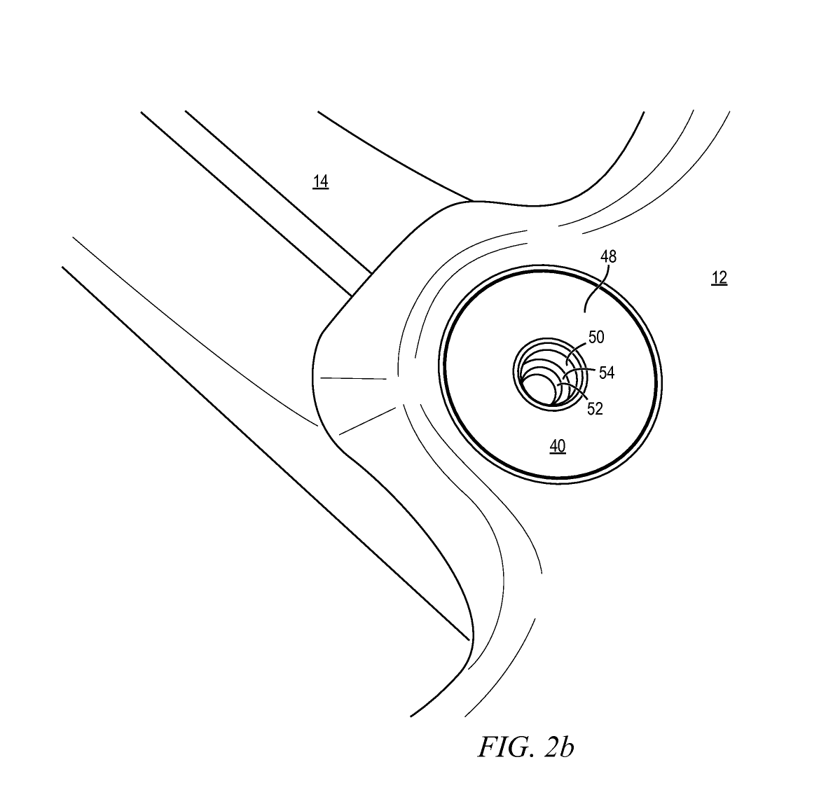

FIG. 2a illustrates the back of guitar 10 while neck 14 is attached to body 12. Wood piece 34 fills a trench or cavity in the neck used to install a truss rod. The truss rod is inserted into the back of neck 14 and then wood piece 34 is glued into the neck over the truss rod. In other embodiments, wood piece 34 is held in by other means besides adhesive, such as screws, pins, or other fasteners. In some embodiments, a truss rod is installed into neck 14 by drilling a hole through the length of the neck. Wood piece 34 is then only used at the ends of neck 14 over portions of the neck where other truss rod related hardware is installed.

Rear plate 40 is inserted into a recess or counterbore formed in the backside of body 12. The counterbore is created to approximately the same size as rear plate 40 so that the top surface of the rear plate sits approximately flush, or coplanar, with the back surface of body 12. In other embodiments, rear plate 40 extends beyond the back surface of body 12 or sits below the back surface of body 12. In one embodiment, no counterbore is formed in body 12, and rear plate 40 exists completely on top of the back surface of the body. Rear plate 40 is formed from titanium, aluminum, stainless steel, or other suitable materials. Rear plate 40 is machined with a computer aided design (CAD) device, stamped, forged, cast, or made in another suitable process.

Bolt 42 extends through rear plate 40 and body 12 to attach to neck 14. Bolt 42 is any screw or other threaded fastener in other embodiments. Bolt 42 is a single fastening element that is removed or loosened to detach neck 14 of guitar 10 from body 12. By removing a single bolt 42, neck 14 is detached from body 12. Detaching neck 14 allows access to the heel portion of the neck and the area under pickguard 25. The heel of neck 14 is the end of the neck that is oriented toward body 12 when the neck is properly installed on guitar 10. Using only a single bolt 42 to attach neck 14 to body 12 also allows easy replacement or repair of the neck, and compact storage of guitar 10.

While rear plate 40 sits in a counterbore of body 12, the rear plate also includes a counterbore that bolt 42 fits in. When tightened, a head portion of bolt 42 sits in a counterbore of rear plate 40 so that the top of the bolt is approximately coplanar with the back surfaces of rear plate 40 and body 12. In some embodiments, bolt 42 extends over rear plate 40 or sits recessed below the top surface of the rear plate. In other embodiments, rear plate 40 does not include a counterbore and a head portion of bolt 42 sits completely over rear plate 40. A threaded portion of bolt 42 mates with a metal plate installed on neck 14, allowing the bolt to be tightened to hold the neck against body 12. Bolt 42 includes a hex key socket head. Other drive types, such as Phillips, Torx, or a thumbscrew are used in other embodiments. Bolt 42 is formed from titanium, aluminum, stainless steel, or other suitable materials. Bolt 42 is a single threaded fastener holding neck 14 onto body 12.

Rear plate 40 distributes the load of bolt 42 onto a larger surface area of body 12, similar to a washer. A washer is used for rear plate 40 in some embodiments. As bolt 42 is tightened, the head portion of the bolt applies a force against a small area of rear plate 40, i.e., the portion of the rear plate directly between the body and the bolt. The load distribution provided by rear plate 40 causes the force from bolt 42 to be distributed to substantially the entire area of body 12 under the rear plate, which is a larger area than the portion of the rear plate under the bolt. Rear plate 40 reduces the total force per area experienced by body 12, thus reducing the likelihood of damage to the body.

Opening or cavity 44 is formed in the backside of body 12. Cavity 44 holds a vibrato module when guitar 10 is completely assembled. The vibrato module allows a player to alter the pitch of a note played on guitar 10 by operating an arm on the front of the guitar.

FIG. 2b illustrates guitar 10 with bolt 42 removed. Rear plate 40 includes a disk portion 48. Counterbore 50 is formed in a central area of rear plate 40 surrounded by disk portion 48. Opening or hole 52 is formed through a bottom surface of counterbore 50. A portion of the bottom surface of counterbore 50 remains as flange 54. In the illustrated embodiment, disk portion 48, opening 52, and counterbore 50 are coaxial or concentric circles, but in other embodiments the opening and counterbore are not coaxial, and are other shapes.

With bolt 42 removed, neck 14 is loose from body 12. Neck 14 falls away from body 12 if the neck of guitar 10 is not properly supported independent of the body. If strings 16 remain attached between headstock 20 and bridge 18, neck 14 remains attached to body 12 via the strings. Care should be taken not to tangle or damage the strings. Rear plate 40 is also loose from body 12 when bolt 42 is removed. Rear plate 40 falls away from body 12 if guitar 10 is oriented with the rear plate toward Earth due to the force of gravity, but the rear plate remains in or on the body if the rear plate is oriented away from Earth. Rear plate 40 is also removed by inserting a finger or tool into counterbore 50 or opening 52 and pulling the rear plate out of the larger counterbore formed in body 12. In some embodiments, rear plate 40 snaps into body 12, or is otherwise held onto the body independent of bolt 42.

To reattach neck 14 to body 12, a threaded cylindrical portion of bolt 42 is inserted through opening 52 until threads of the bolt contact neck 14. With neck 14 properly aligned relative to body 12, external threading of bolt 42 contacts an opening of neck 14 that includes internal threading matching the specification of the bolt threading. Body 12 and rear plate 40 do not include threading. Bolt 42 extends through body 12 and rear plate 40, but is not mated directly to the body or rear plate by similar threading.

Bolt 42 is turned relative to neck 14 and body 12 using a screwdriver, drill, Allen key, by hand, or by other means effective for the type of bolt used. As bolt 42 turns relative to neck 14, the threading on the bolt engages with the threading on the neck. As bolt 42 is turned further, the head portion of the bolt moves closer to neck 14. The head portion of bolt 42 fits into counterbore 50, and applies a force against flange 54 toward neck 14. The force of bolt 42 against flange 54 as the bolt turns pulls neck 14 closer to body 12 if any excess space exists between the neck and body. The interlocking threads between neck 14 and bolt 42 provides a similar but opposite force that holds the bolt onto the neck. Fully tightening bolt 42 squeezes body 12 between neck 14 and rear plate 40, thereby keeping the neck in a substantially fixed positional relationship with the body as required for proper guitar performance. Bolt 42 is a single fastener that, when removed from guitar 10, allows neck 14 to be separated from body 12.

FIG. 2c illustrates guitar 10 with rear plate 40 removed, in addition to bolt 42 being removed. Body 12 includes a first counterbore 70 and a second counterbore 72 that is smaller in diameter but larger in depth than first counterbore 70. Recess 74 is formed within the footprint of counterbore 70. Opening 76 is formed completely through body 12 within the footprint of counterbore 72. In the illustrated embodiment, counterbore 70, counterbore 72, and opening 76 are coaxial or concentric circles. Recess 74 accepts a tab formed on a back surface of rear plate 40. With bolt 42 removed from guitar 10, rear plate 40 sits loose within counterbores 70 and 72, and is easily removed using a finger, tool, or gravity.

Counterbore 70, counterbore 72, and recess 74 together form approximately the same shape as rear plate 40. Counterbore 70 is large and flat similar to shape of disk portion 48 of rear plate 40. Counterbore 72 is deeper and designed to receive counterbore 50 of rear plate 40. When guitar 10 is assembled, counterbore 50 of rear plate 40 sits within counterbore 72 of body 12, and a head portion of bolt 42 sits within counterbore 50 of the rear plate. Bolt 42 applies a force to flange 54, and rear plate 40 distributes the load of the bolt over the surface area of counterbores 70 and 72. A threaded portion of bolt 42 extends through opening 76 of body 12 to reach and attach to neck 14.

A tab formed on the back of rear plate 40 fits into recess 74. Recess 74 prevents substantial rotation of the rear plate within counterbores 70 and 72. Rotation of rear plate 40 occurs when bolt 42 is turned during installation of the bolt. Friction between rear plate 40 and body 12 wears down the body within counterbores 70 and 72, damaging guitar 10. Recess 74 accepting a tab of rear plate 40 reduces wear and tear on body 12.

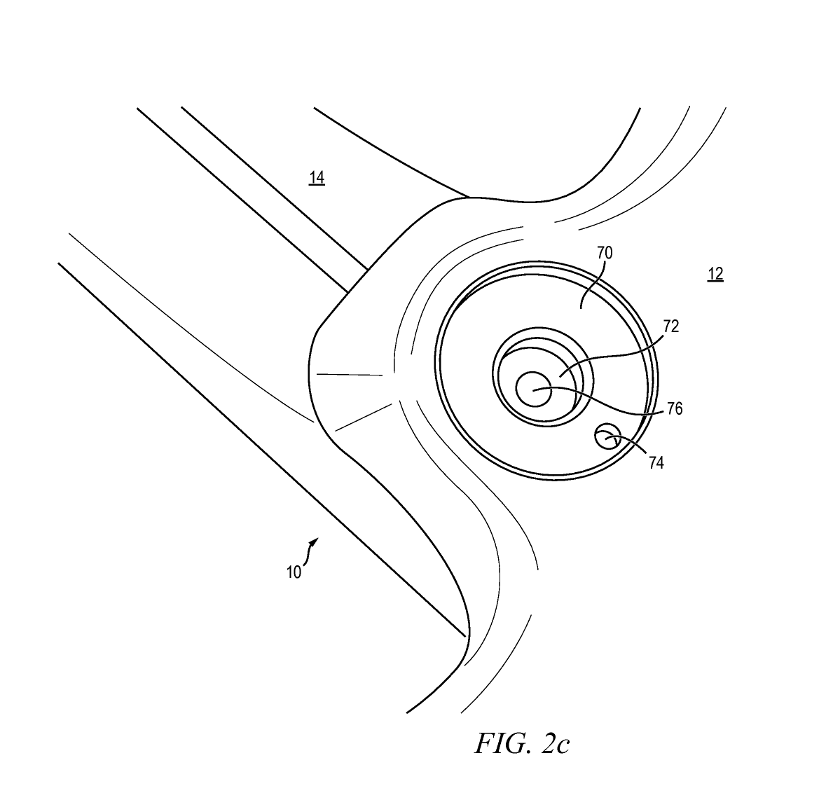

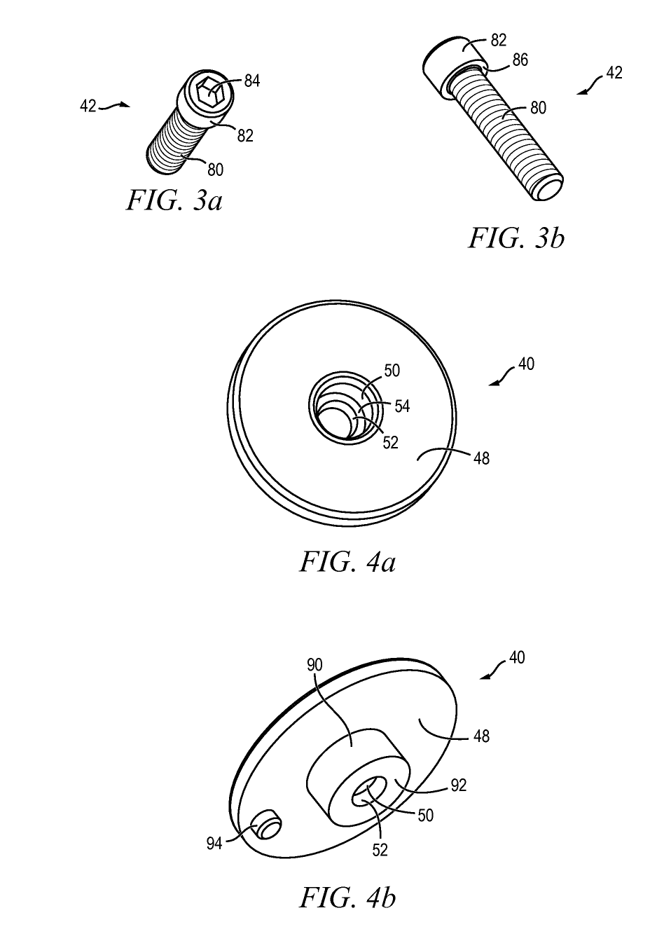

FIG. 3a illustrates bolt 42 removed from guitar 10. Bolt 42 includes a shank or threaded cylinder portion 80 and head portion 82. Head portion 82 of bolt 42 includes drive recess 84. Threaded portion 80 is a metal cylinder with a helical ridge formed around the cylinder. The helical ridge is a male or external thread. The threaded portion 80 of bolt 42 fits through opening 52 of rear plate 40 and opening 76 of body 12. Threaded portion 80 is long enough to extend through openings 52 and 76 and reach neck 14. Neck 14 includes a metal plate or other structural element that includes female or internal threading corresponding to threading 80 of bolt 42. Rotating bolt 42 slides threading 80 into the internal threading of neck 14.

The interlocking threading between neck 14 and bolt 42 reduces movement of the bolt along an axis through the length of the bolt. Rotational movement of bolt 42 around the axis through the length of the bolt moves head portion 82 closer or farther away from neck 14 due to the helical shape of threading 80. The axis through the length of bolt 42, or simply the axis through the bolt, refers to an axis extending from the center of head portion 82 down the center of threaded portion 80 and out the center of the end of bolt 42 opposite the head. In some embodiments, bolt 42 includes a cylindrical portion between threaded portion 80 and head portion 82 that does not include the helical ridge of the threaded portion. In other words, the helical ridge formed around the cylindrical body of bolt 42 may only extend partially between head portion 82 and the opposite end of the bolt. An unthreaded section of the shank of bolt 42 gives a closer fit between bolt 42 and openings 52 and 76, which helps keep neck 14 aligned properly with body 12.

Head portion 82 of bolt 42 is wider than threaded portion 80, and includes a lip that presses against flange 54 of rear plate 40. Threaded portion 80 of bolt 42 fits through openings 52 and 76, but head portion 82 does not fit through the openings. Instead, head 82 contacts flange 54 to apply a force against rear plate 40.

Head portion 82 includes driving recess 84. Driving recess 84 is designed to receive a tool used to turn bolt 42. The tool used is approximately the same shape as driving recess 84, and approximately fills the driving recess. The illustrated embodiment includes a hexagonal driving recess 84. A hex key or Allen wrench is inserted into driving recess 84 to turn bolt 42. In other embodiments, other types of screwdrivers or tools are used instead of a hexagonal tool. In one embodiment, bolt 42 is externally driven. A ratchet or other tool fits around head portion 82 of bolt 42 to turn the bolt. When bolt 42 is externally driven, counterbore 50 of rear plate 40 includes a greater diameter than the bolt in order to accommodate both the bolt and the tool.

With a tool inserted into driving recess 84, an operator rotates the tool to also rotate bolt 42. The rotation of bolt 42 causes the helical ridge of threaded portion 80 to extend further into the threading of neck 14. Rotating bolt 42 in one direction, typically clockwise, extends threading 80 of bolt 42 farther into the threading of neck 14, moving head portion 82 closer to the neck. Rotating bolt 42 in the opposite direction, typically counterclockwise, reduces the amount of threading 80 interlocked with the threading of neck 14, thus moving head portion 82 farther from neck 14. When installing neck 14, turning bolt 42 initially moves the neck closer to body 12, or bolt head 82 closer to body 12 and rear plate 40. Once neck 14 contacts body 12 and head portion 82 contacts rear plate 40, further turning bolt 42 increases the force with which bolt 42 holds the body against the neck. The tool inserted into driving recess 84 increase the amount of torque that an operator of the tool applies against bolt 42. Higher torque reduces the difficulty of turning bolt 42, and potentially increases the tightness of the fit of body 12 between neck 14 and bolt head 82 achievable by an end user.

Lip 86 of bolt 42 is visible in FIG. 3b. Lip 86 presses against flange 54 when bolt 42 is installed in guitar 10. Lip 86 is a thin portion of metal that bears substantially the entire force holding neck 14 against body 12. The large force per area of lip 86 pressing against flange 54 is spread out by rear plate 40 into a smaller force per unit area against body 12. Without rear plate 40, the material body 12 is formed from, commonly wood with a lacquer or veneer finish, is easily damaged by the higher force per area of lip 86.

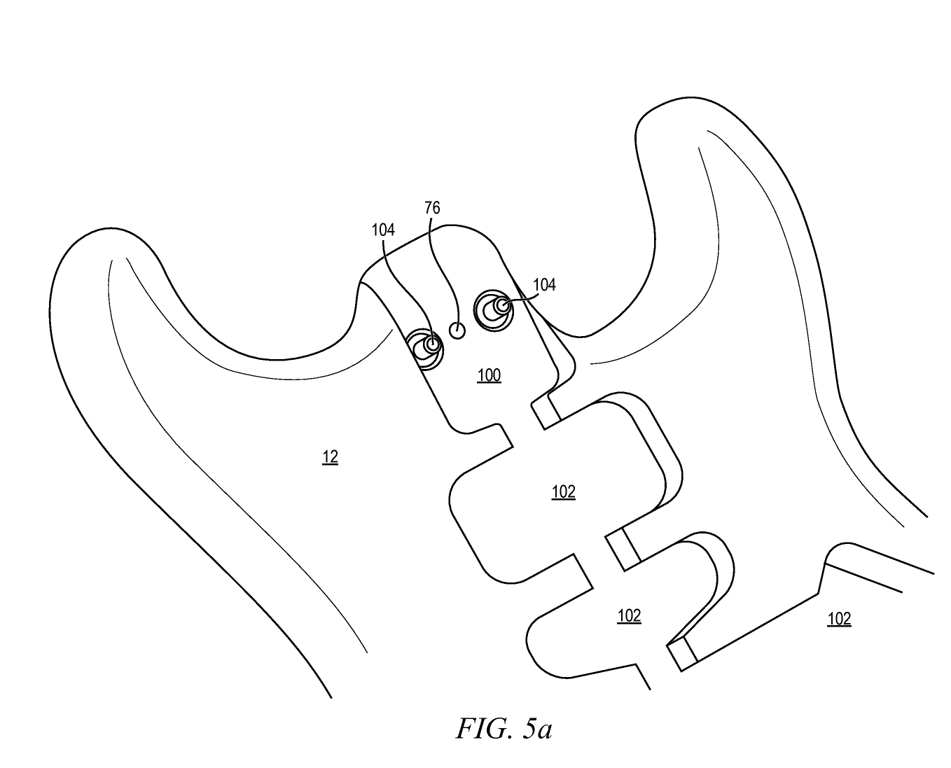

FIG. 4a illustrates rear plate 40 removed from body 12. Disk portion 48 fits into counterbore 70. The physical shape of counterbore 50 fits into counterbore 72 of body 12. Opening 52 aligns with opening 76 of body 12 so that bolt 42 is inserted through both openings. Counterbore 50 is approximately the same size as head portion 82 of bolt 42, although is larger in other embodiments. Flange 54 is approximately the same size as lip 86 of bolt 42. Disk portion 48 has approximately the same diameter as counterbore 70 of body 12. In other embodiments, rear plate 40 is other shapes besides circular.

FIG. 4b shows the bottom or backside of rear plate 40. Counterbore 50 provides a protuberance 90 extending from disk portion 48. Protuberance 90 is approximately the same size as counterbore 72 of body 12. Protuberance 90 includes a bottom surface 92 on the underside of flange 54. Opening 52 is formed through surface 92. When bolt 42 is installed and tightened, lip 86 of the bolt applies a force against flange 54. Rear plate 40 spreads the force out to the area of disk portion 48 and surface 92. Surface 92 presses against the bottom surface of counterbore 72, and disk portion 48 presses against the bottom surface of counterbore 70.

Tab 94 fits into recess 74 when rear plate 40 is installed in guitar body 12. Tab 94 includes a diameter and depth approximately equal to recess 74, so that the tab approximately fills the recess when rear plate 40 is installed. In other embodiments, recess 74 includes a greater depth than tab 94 so that some space remains unfilled in the recess when rear plate 40 is installed. Tab 94 stops rear plate 40 from rotating within body 12 as bolt 42 is rotated to tighten neck 14 against the body. A sidewall of tab 94 presses against a sidewall of recess 74, reducing rotation of rear plate 40. In some embodiments, recess 74 is larger across or shaped differently than tab 94. Rear plate 40 rotates within body 12 until a sidewall of tab 94 contacts a sidewall of recess 74. Tab 94 helps maintain a desired orientation of rear plate 40 relative to body 12, which results in any logo or other design feature on the rear plate appearing properly. Reducing rotation of rear plate 40 against body 12 also reduces wear and tear of the contacting surfaces.

In one embodiment, counterbore 50 is formed off center relative to disk portion 48. Opening 52 may still be concentric with counterbore 50, but counterbore 50 is not concentric with disk portion 48. As rotational force is applied to rear plate 40 by a user turning bolt 42, a sidewall of disk portion 48 presses against a sidewall of counterbore 70. Having counterbore 50 nonconcentric with disk portion 48 reduces rotation of rear plate 40 without the use of tab 94 and recess 74. In other embodiments, the sidewall of protuberance 90 includes a jutting or extending portion to reduce rotation of rear plate 40 instead of using a separate tab 94.

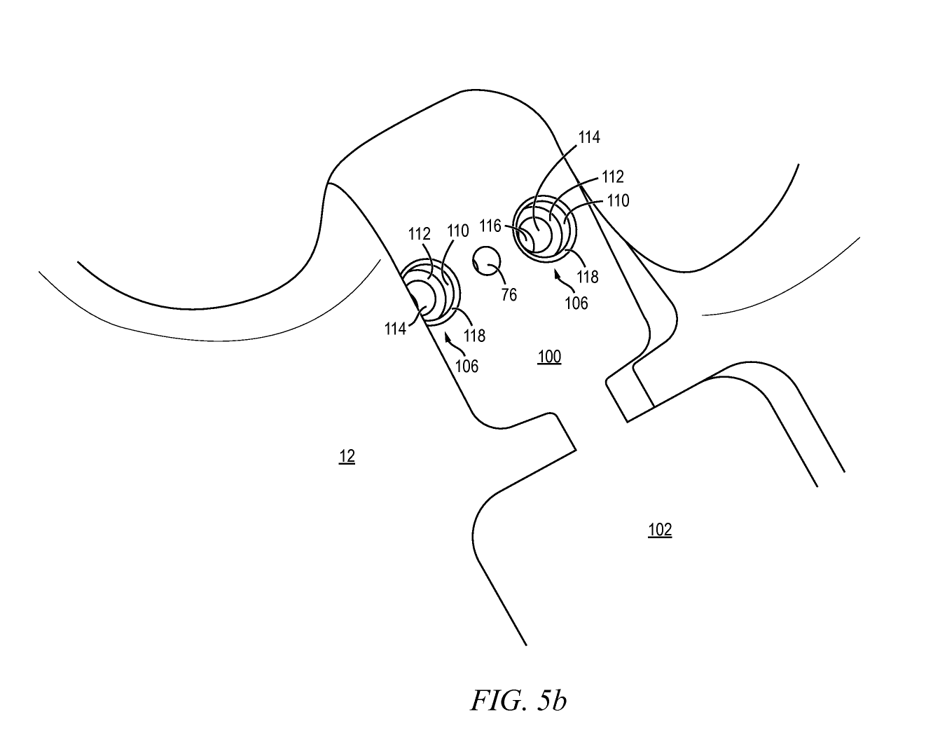

FIG. 5a illustrates body 12 after removal of neck 14. Body 12 in FIG. 5a also has pickguard 25, pickups 26, and other components removed. Cavity 100 is the portion of body 12 where neck 14 sits when installed. Bolt 42 extends through opening 76 when guitar 10 is assembled, and holds neck 14 into cavity 100. Cavities 102 accommodate pickups 26 and other mechanical or electrical components of guitar 10 that reside within body 12. Shoulder pins 104 are disposed within recesses of body 12 and extend over body 12 in cavity 100. In one embodiment, shoulder pins 104 are press fit into body 12 so that the shoulder pins are not easily removable by an end user of guitar 10. Neck 14 includes corresponding recesses or openings that fit over shoulder pins 104 opposite body 12.

Cavity 100 is approximately the same shape as, or at least as wide as, the heel of neck 14. To install neck 14 on body 12, the neck is pushed down onto shoulder pins 104 and disposed in cavity 100. In embodiments where cavity 100 is larger than the heel of neck 14, some space exists between the neck and the sidewalls of cavity 100. Pickguard 25 can be shaped to cover the excess space, which improves appearance and reduces liquids or particles of matter getting into cavity 100 around neck 14. Cavity 100 can be larger than the heel of neck 14 because shoulder pins 104 are used to align the neck and body. Contact between the sidewalls of cavity 100 and neck 14 is not required to keep neck 14 stationary and properly aligned relative to body 12.

Shoulder pins 104 are formed from titanium, aluminum, stainless steel, or other suitable materials. Shoulder pins 104 operate as dowels or alignment pins to align neck 14 relative to body 12. When neck 14 is placed into cavity 100, shoulder pins 104 are inserted into openings on the neck. Shoulder pins 104 and the openings of neck 14 are machined to a high tolerance to be approximately the same size, or shoulder pins 104 are slightly smaller. Shoulder pins 104 freely slip into and out of the openings of neck 14, but have very little play when disposed in the neck. Play describes the amount of movement shoulder pins 104 are able to exhibit within neck 14. The relative sizes of shoulder pins 104 and openings in neck 14 keeps the neck from significantly moving rotationally around the axis through the length of bolt 42. In other embodiments, shoulder pins 104 are slightly wider than the openings of neck 14. Friction between neck 14 and shoulder pins 104 causes some force to be required to press the neck down over the shoulder pins and into cavity 100, known as a press fit or interference fit. Shoulder pins 104 are machined to be slightly larger to require a greater force to install and remove neck 14, or slightly smaller to require less force to install and remove neck 14.

After neck 14 is inserted onto shoulder pins 104 and into cavity 100, bolt 42 is inserted through opening 76 from the opposite side and attached to neck 14. The force of bolt 42 pulls neck 14 against the bottom surface of cavity 100. The bottom surface of cavity 100 is the surface that opening 76 is formed through. The force of bolt 42 pressing a surface of neck 14 against the surface of cavity 100 reduces the amount of movement of the neck, substantially preventing movement or rotation about axes other than the axis through the length of bolt 42. Friction between the bottom surface of cavity 100 and neck 14 increases the force required to rotate neck 14 around the axis through bolt 42 without shoulder pins 104. However, without shoulder pins 104, rotation of neck 14 relative to body 12 still occurs even given the friction between the neck and body. Shoulder pins 104 greatly increase the force required to move neck 14 relative to body 12 to the point that significant movement is unlikely during normal usage of guitar 10.

Shoulder pins 104 maintain alignment of neck 14 relative to body 12, so that bolt 42 is not important for alignment. Shoulder pins 104 allow only a single bolt 42 to be used. Without shoulder pins 104, two bolts would be needed to maintain alignment of neck 14 around the axis through bolt 42. Shoulder pins 104 align neck 14 so that only a single bolt 42 is used. In some embodiments, a single bolt 42 and a single shoulder pin 104 are sufficient to align neck 14 with body 12.

FIG. 5b illustrates body 12 with shoulder pins 104 removed. Body 12 includes two recesses 106 extending below cavity 100 for insertion of shoulder pins 104. Each recess 106 includes a first sidewall 110 with a first diameter. A ledge 112 connects sidewall 110 to sidewall 114. Sidewall 114 extends deeper into body 12 than sidewall 110, and includes a narrower diameter. A bottom 116 of recesses 106 is visible. In some embodiments, recesses 106 extend completely through body 12. Rear plate 40 is sized to cover the bottom sides of recesses 106 when guitar 10 is assembled. Shoulder pins 104 are short enough to fit in recesses 106 and not extend past the opposite surface of body 12. Each opening includes a chamfer or bevel 118 around the top circumference of sidewall 110. Chamfer 118 helps guide shoulder pin 104 into recesses 106. The sloped surfaces of chamfers 118 guide shoulder pins 104 toward the center of recesses 106.

Shoulder pins 104 include a similar shape to recesses 106, with a larger diameter in a center portion of the shoulder pins and a narrower diameter toward the end that is inserted into recesses 106. Shoulder pins 104 are formed with slightly larger diameters than sidewalls 110 and 114 so that the shoulder pins are press fit into body 12. In other embodiments, shoulder pins 104 are formed with a size approximately equal to or slightly smaller than recesses 106 so that the shoulder pins freely slip into and out of recesses 106. In some embodiments, shoulder pins 104 freely slip in and out of neck 14, while a press fit is used to hold the shoulder pins in body 12. The reverse is also possible, with a press fit used to hold shoulder pins 104 into neck 14. When a press fit is used to hold shoulder pins 104 into either body 12 or neck 14, the shoulder pins reliably stay with one portion of guitar 10, and are less likely to inadvertently fall and roll away.

To assemble guitar 10, shoulder pins 104 are first inserted into recesses 106. If a press fit is used, the step of inserting shoulder pins 104 into recesses 106 is generally performed at a manufacturer of guitar 10 rather than by an end user. The remaining assembly steps are performed initially by the manufacturer or by an end user after dismantling guitar 10. Neck 14 is inserted over shoulder pins 104 and into cavity 100. Rear plate 40 is inserted into counterbores 70 and 72. Bolt 42 is inserted through openings 52 and 76 and screwed into neck 14. Guitar 10 can also be assembled by first disposing shoulder pins 104 into neck 14, possibly using a press fit by the manufacturer. Neck 14 and shoulder pins 104 are placed into cavity 100 and recesses 106 as a single unit, followed by installation of bolt 42.

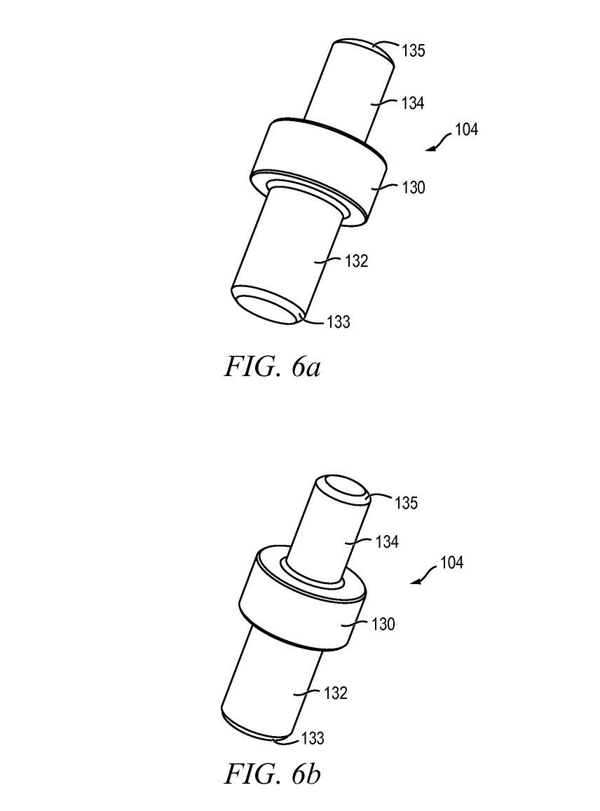

FIGS. 6a-6b show an individual shoulder pin 104, removed from body 12 and neck 14. FIG. 6a illustrates shoulder pin 104 with the body 12 side oriented toward the viewer. FIG. 6b illustrates shoulder pin 104 with the neck 14 side oriented toward the viewer. Shoulder pin 104 includes three portions with circular cross-sections having three different diameters. Portion 130 is the thickest part of shoulder pin 104, and portion 132 is substantially narrower than portion 130. Portions 130 and 132 of shoulder pin 104 are inserted into recess 106 to assemble guitar 10. Portion 130 of shoulder pin 104 includes approximately the same diameter and length as sidewall 110 of recess 106, or is slightly larger for a press fit. Portion 132 of shoulder pin 104 includes approximately the same diameter and length as sidewall 114 of recess 106, or is slightly larger for a press fit. Shoulder pin 104 can be press fit into body 12 by portion 130 only, portion 132 only, or both. The end of portion 132 opposite portion 130 includes a beveled or chamfered edge 133. Chamfer 133 contacts ledge 112 when inserting shoulder pin 104 into recess 106 to guide portion 130 into the middle of sidewall 114. The joint where portion 130 meets portion 132 is optionally filleted. The edge of portion 130 toward portion 132 is optionally rounded.

Portion 134 of shoulder pin 104 is slightly narrower than portion 132, and approximately the same circumference or diameter as an opening formed in the neck. An edge 135 at the end of portion 134 opposite portion 130 is beveled or chamfered to help guide shoulder pin 104 into the opening of neck 14. The joint where portion 130 and portion 134 meet is optionally filleted. The edge of portion 130 toward portion 134 is optionally rounded.

In the illustrated embodiment, portions 132 and 134 include different diameters. In other embodiments, larger or smaller diameters are used depending on the requirements of the particular application. Portions 132 and 134 have the same circumference or diameter in some embodiments. Portions 130 and 132 of shoulder pin 104 are inserted into recess 106 of body 12 while portion 134 is inserted into neck 14. In other embodiments, portion 130 is partially inserted into neck 14 and partially inserted into body 12. In some embodiments, portion 130 is inserted into neck 14 instead of body 12. A thicker portion 130 is not used in all embodiments. In some embodiments, a dowel pin is used instead of shoulder pin 104. Dowel pins, also known as dowel rods, dowels, or straight pins, include a substantially uniform thickness along the entire length of the pin, with or without chamfered ends. Coiled spring pins, slotted spring pins, grooved pins, square pins, or other types of pins are used in other embodiments.

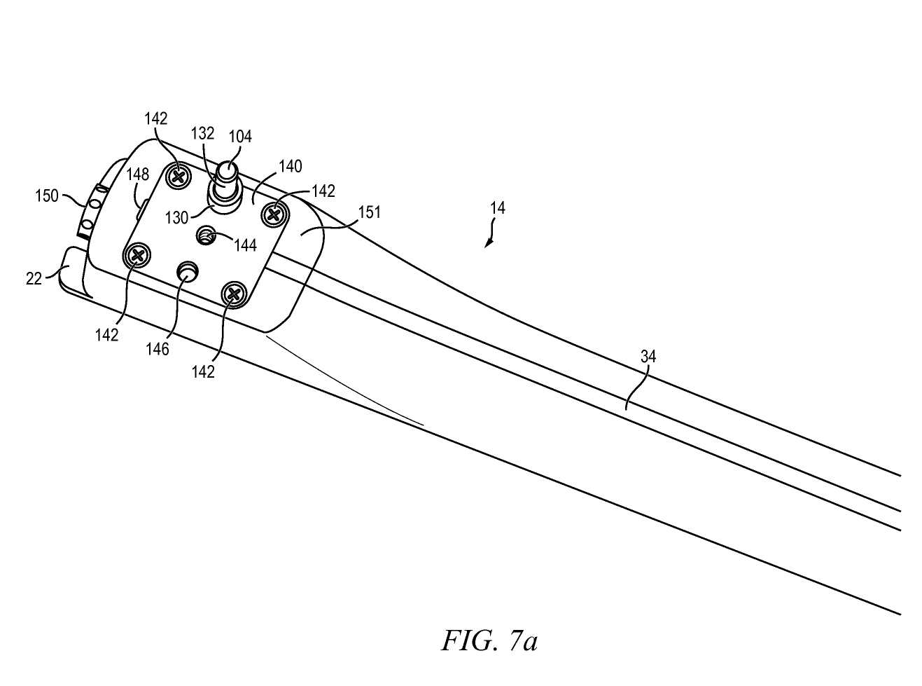

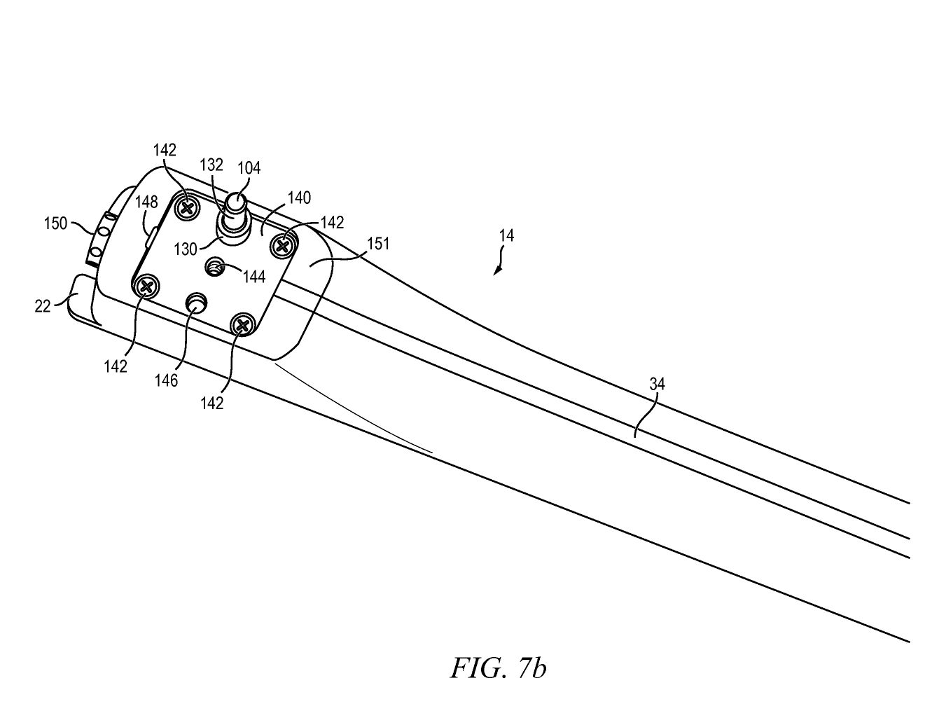

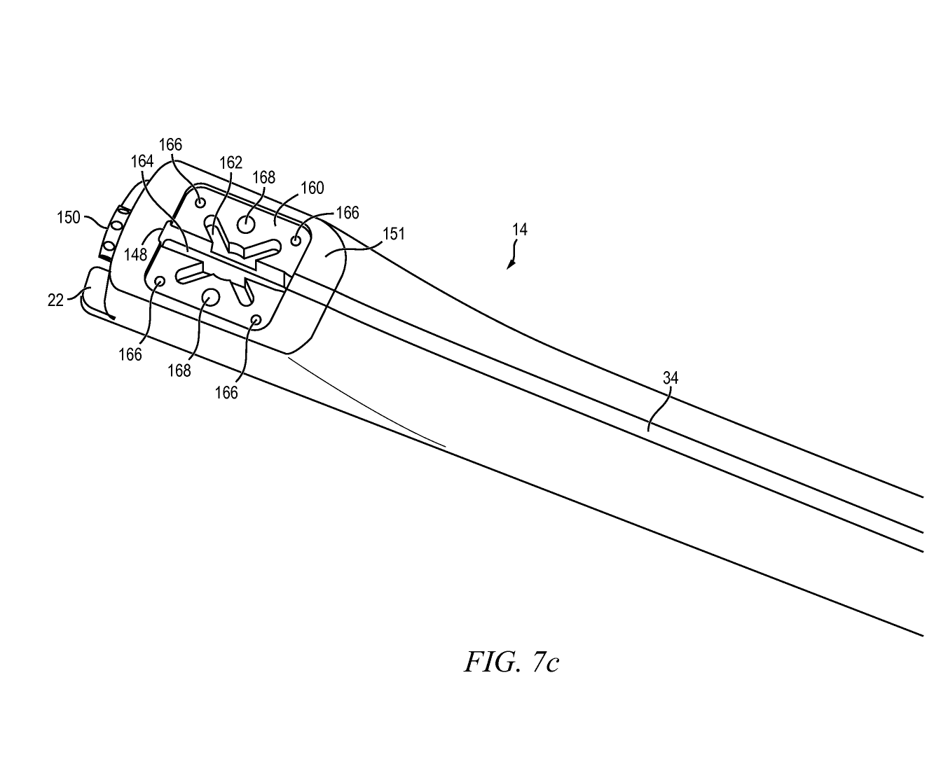

FIG. 7a illustrates the heel of neck 14 of guitar 10 that connects to body 12. Neck plate 140 is screwed onto neck 14 using four wood screws 142. An internally threaded opening 144 is formed through the center of neck plate 140 to accept bolt 42. Two openings 146 are formed through plate 146 flanking opening 144 to accept portions 134 of shoulder pins 104. Tab 148 is part of an opening extending into neck 14. A thumbscrew 150 at the end of the heel of neck 14 allows adjustment of the neck's truss rod.

Neck plate 140 is formed from titanium, aluminum, stainless steel, or other suitable materials. Neck plate 140 adds strength to the neck joint of guitar 10. The threads of bolt 42 turn into threads of opening 144. Opening 144 includes a chamfered or beveled edge to help guide bolt 42 into the opening. Both bolt 42 and neck plate 140 are formed from similar metallic materials. The strength of the connection between bolt 42 and plate 140 is substantially stronger than a single bolt 42 screwed directly into the wooden portion of neck 14.

Neck plate 140 is attached to neck 14 using a plurality of wood screws 142. Four wood screws 142 are used in the illustrated embodiment, although any number of wood screws are used in other embodiments to meet the strength requirements of guitar 10. Neck plate 140 is disposed in a cavity of neck 14 such that the top surface of the neck plate visible in FIG. 7a is approximately coplanar with the surrounding surface 151 of the neck. Wood screws 142 utilize a Phillips driving recess, but other types of drives are used in other embodiments. Wood screws 142 are countersunk into neck plate 140, so that the top surfaces of the wood screws are approximately coplanar with the surrounding surfaces of neck plate 140 and neck 14. Neck 14, neck plate 140, and wood screws 142 present a surface to body 12 that is substantially flat across the entire mating surfaces. When neck 14 is disposed in cavity 100 of body 12, neck 14 lies flat against the body to promote alignment and stability of the neck.

In other embodiments, neck plate 140 is recessed or subflush within neck 14, as shown in FIG. 7b. The top surface of neck plate 140, visible in FIG. 7b, is recessed within neck 14. That is, the top surface of neck plate 140 is at a level lower than the surrounding surface 151 of neck plate 140. When guitar 10 is assembled, surface 151 of neck 14 contacts body 12 within cavity 100. Neck plate 140 does not contact body 12 because the recess creates separation between the neck plate and body. The recessed neck plate 140 improves stability by distributing the force of bolt 42 to a ring of contact around the bolt between neck 14 and body 12. The stability of neck 14 only depends on manufacturing surface 151 flat. With neck plate 140 and surface 151 coplanar, alignment between wood screws 142, neck plate 140, and surface 151 is important to stability.

Opening 144 includes female threading that is complementary to the male threading of bolt 42. In one embodiment, opening 144 includes a major diameter of 0.25 inches and a thread count of 20 threads per inch. Bolt 42 is disposed through rear plate 40 and body 12 and screwed into opening 144. Neck plate 140 distributes the forces of the single bolt 42 to the four wood screws 142 so that each individual wood screw experiences less pulling force than bolt 42. Reducing the force any individual screw applies directly to neck 14 increases the force on bolt 42 required to pull the screws out of the neck.

Openings 146 are approximately the same diameter as portion 134 of shoulder pin 104. Shoulder pins 104 are press fit into recesses 106 of body 12, and neck 14 easily slides into cavity 100 with the shoulder pins inserted into openings 146. In other embodiments, shoulder pins 104 are press fit into neck plate 140. Neck 14 is disposed in cavity 100 with shoulder pins 104 disposed in openings 146 and recesses 106 prior to bolt 42 being installed. Openings 146 include a chamfered or beveled edge to guide shoulder pins 104 into the openings.

FIGS. 7a-7b illustrate a single shoulder pin 104 inserted into one opening 146 to help orient FIGS. 7a-7b relative to FIG. 5a, which has the shoulder pins press fit into body 12. With shoulder pins 104 press fit into recesses 106 of body 12, a shoulder pin would generally not be inserted into an opening 146 with neck 14 separate from the body. However, shoulder pin 104 in FIGS. 7a-7b illustrates how a shoulder pin sits relative to neck 14 when guitar 10 is assembled. Shoulder pins 104 include very little play within openings 146, so that neck 14 has very little play relative to body 12 when guitar 10 is assembled. Shoulder pins 104 maintain the alignment between body 12 and neck 14 by reducing the movement that the neck is able to exhibit relative to the body, allowing only a single bolt 42 to be used.

Tab 148 extends into neck 14. Tab 148 accommodates a flat-head screwdriver or other tool that can be used to pry neck plate 140 out of neck 14. In some embodiments, neck plate 140 falls out of neck 14 easily when screws 142 are removed, while in other embodiments some leverage is required.

Thumbscrew 150 is attached to a truss rod disposed through the middle of neck 14. The truss rod extends from thumbscrew 150 to near headstock 20. Thumbscrew 150 adjusts the tension of the truss rod in neck 14, which controls the curvature of the neck. Thumbscrew 150 is turned by hand or using a tool inserted into the end of the thumbscrew when neck 14 is removed from body 12. Thumbscrew 150 is adjusted without removing neck 14 by removing pickguard 25. With pickguard 25 removed, a tool is inserted through an opening of fretboard 22 over thumbscrew 150 and into recesses formed around the circumference of the thumbscrew. Thumbscrew 150 is then turned by rotating the thumbscrew with the tool.

In FIG. 7c, neck 14 is shown with neck plate 140 removed. Cavity 160 is approximately the same size as neck plate 140, so that the neck plate fits snugly into cavity 160 without extending outside of the cavity. In the embodiment of FIG. 7b, cavity 160 is formed to a greater depth than the thickness of neck plate 140. Recess 162 is formed within the footprint of cavity 160. Recess 162 is formed to accommodate reinforcing ridges on a backside of neck plate 140. Recess 162 is in the shape of an ‘X’ in the disclosed embodiment because reinforcing ridges of neck plate 140 are in the shape of an ‘X’. However, other reinforcing ridge shapes are used in other embodiments, and recess 162 is shaped accordingly.

Trench 164 is formed along the length of neck 14 and is significantly deeper than cavity 160 and recess 162. Trench 164 extends in depth most of the way through neck 14, and in length nearly the entire length of neck 14. Trench 164 extends beyond neck plate 140 toward the heel of neck 14 to form tab 148. A truss rod is installed in trench 164, and then the portion of trench 164 that is exposed when guitar 10 is assembled is filled with wood piece 34. Screw holes 166 are drilled into neck 14 to receive wood screws 142. In one embodiment, screw holes 166 are initially formed without threading, and the threading of wood screws 142 digs into the sidewall of the screw holes to grip neck 14.

To assemble neck 14, neck plate 140 is disposed within cavity 160 and recess 162. Cavity 160 is approximately the same depth as the thickness of neck plate 140, which results in the top surface of the neck plate being approximately coplanar with the surrounding surface of neck 14. In other embodiments, cavity 160 includes a greater depth into neck 14 than the thickness of neck plate 140, so that the top surface of the neck plate is recessed within the neck. Wood screws 142 are screwed into screw holes 166 through openings of neck plate 140 after the neck plate is disposed in cavity 160. Once neck plate 140 is installed on neck 14 with screws 142, there is no need to remove the neck plate from the neck to disassemble the neck from body 12. Neck 14 is removed from body 12 by merely disconnecting bolt 42 while neck plate 140 remains installed on neck 14.

Recesses 168 are formed into neck 14 to accommodate portions 134 of shoulder pins 104. In one embodiment, recesses 168 are approximately the same diameter as openings 146 of neck plate 140 so that shoulder pins 104 contact both neck 14 and neck plate 140. In other embodiments, recesses 168 are larger than portion 134 of shoulder pins 104 so that the shoulder pins extends through neck plate 140 without contacting neck 14.

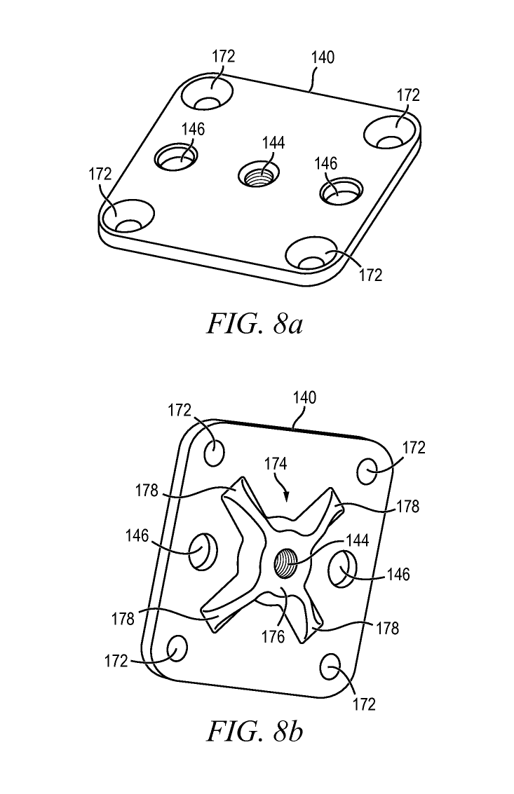

FIG. 8a illustrates neck plate 140 removed from neck 14 as viewed from the front or top of the neck plate. After neck plate 140 is disposed in cavity 160 of neck 14, wood screws 142 are disposed through openings 172 and drilled down into screw holes 166. Openings 172 are beveled so that countersunk wood screws 142 are used. The head portions of wood screws 142 fit substantially within an opening 172 without extending above the top surface of neck plate 140. The tops of screws 142 sit flush with the top surface of neck plate 140. The bevel of openings 172 extends substantially the entire way from the top surface of neck plate 140, shown in FIG. 8a, to the bottom surface of the neck plate, shown in FIG. 8b. In some embodiments, a thicker neck plate 140 is used, and openings 172 include a chamfer that does not extend completely through the neck plate.

Wood screws 142 hold neck plate 140 tightly against neck 14. After installing neck plate 140 into neck 14, the neck is installed within cavity 100 of body 12. Bolt 42 extends through the body and attaches to opening 144 of neck plate 140 using interlocking threads of the opening and the bolt. Wood screws 142 attached to neck 14 through openings 172 hold neck plate 140 onto neck 14, while bolt 42 holds the neck onto body 12 by gripping threads of opening 144. Shoulder pins 104 inserted into body 12 and openings 146 help align neck 14 relative to body 12.

FIG. 8b illustrates neck plate 140 from the bottom or back of the neck plate. Ridge 174 is formed on the back of neck plate 140 to reinforce the neck plate. Ridge 174 includes an approximately circular center portion 176 around opening 144, and four arms 178 that each extend toward one of openings 172. The central portion 176 of ridge 174 lengthens opening 144 to allow for additional threading. The additional threading of opening 144 results in additional length of bolt 42 being gripped by the threading, improving the strength of the attachment between the bolt and neck plate 140.

Arms 178 of ridge 174 each extend toward an opening 172 to strengthen the connection neck plate 140 provides between bolt 42 and screws 142. Bolt 42 connects neck plate 140 to body 12, while screws 142 attach neck plate 140 to neck 14. Therefore, different relative forces on body 12 and neck 14 when guitar 10 is assembled result in a force through neck plate 140 between bolt 42 and the plurality of wood screws 142. Arms 178 add additional material to neck plate 140 along the force lines between bolt 42 and wood screws 142 to help transfer the load of the bolt out to the wood screws.

In one embodiment, neck plate 140 is formed without ridge 174. Neck plate 140 is formed from a portion of sheet metal, i.e., flat on both sides. Opening 144 is still formed with threading to mate with bolt 42. In another embodiment, opening 144 is formed without threading through a piece of sheet metal. A nut attached to the bottom side of neck plate 140 by welding or other means provides threading to mate with the threading of bolt 42. Bolt 42 attaches to the nut through neck plate 140 instead of attaching to threading formed as part of the neck plate.

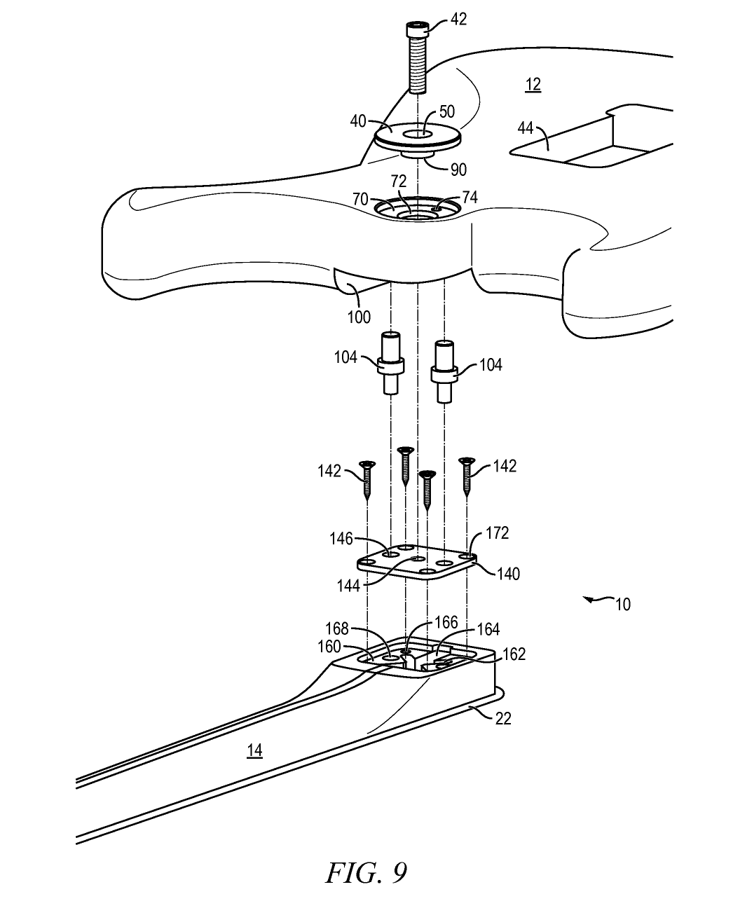

FIG. 9 is an exploded view drawing of guitar 10. In the assembly of guitar 10, the body 12 and neck 14 portions are separately assembled first. As for body 12, shoulder pins 104 are press fit into recesses 106. Insofar as the end user is generally concerned, shoulder pins 104 are permanently lodged within body 12. In some embodiments, shoulder pins 104 are not press fit into body 12, but rather freely slip into and out of recesses 106. In embodiments where shoulder pins 104 are not press fit, the shoulder pins are simply inserted into body 12 or neck 14 prior to disposing the neck in cavity 100. In other embodiments, more or less than two shoulder pins 104 are used.

As for assembling the neck 14 portion, neck plate 140 is attached to the neck using wood screws 142 inserted through openings 172. Neck plate 140 sits within cavity 160 of neck 14. Wood screws 142 are screwed into screw holes 166 of neck 14. With neck plate 140 attached to neck 14, and shoulder pins 104 press fit into body 12, neck 14 is disposed in cavity 100 by sliding openings 146 and recesses 168 over shoulder pins 104.

Once neck 14 is disposed in cavity 100, the neck is attached to body 12 using bolt 42. Rear plate 40 is disposed in counterbores 70 and 72 with tab 94 disposed in recess 74. Bolt 42 is disposed through rear plate 40 and body 12 to contact the threads of opening 144 in neck plate 140. Turning bolt 42 causes external threads of bolt 42 to interlock with internal threads of opening 144, tightening the pressure applied to body 12 between rear plate 40 and neck plate 140. The head portion of bolt 42 applies a force to rear plate 40. Rear plate 40 distributes the pressure of the head of bolt 42 onto a greater surface area of body 12. A similar but opposite force of the threads of bolt 42 on neck plate 140 keeps neck 14 within cavity 100. Shoulder pins 104 disposed in body 12, neck 14, and neck plate 140 reduces the amount that the neck rotates in the plane parallel with the neck plate. Only a single bolt 42 is used because shoulder pins 104 align neck 14 without the need for a second bolt.

Guitar 10 can be dismantled again by simply unscrewing and removing bolt 42. With bolt 42 removed, neck 14 easily slides off shoulder pins 104 and out of cavity 100. With neck 14 removed, several internal components of guitar 10 are accessible, and neck 14 is replaceable. Removal of neck 14 from body 12 with a single bolt reduces the work of a user of guitar 10 making tweaks or repairs to guitar 10. Neck 14 is removed without having to remove wood screws from the neck, which risks stripping screw holes or otherwise damaging the neck. Wood screws 142 are shorter than wood screws that extend through body 12, reducing the leverage that is applied against the wood portion of neck 14 and reducing the likelihood of damage to the neck.

While one or more embodiments of the present invention have been illustrated in detail, the skilled artisan will appreciate that modifications and adaptations to those embodiments may be made without departing from the scope of the present invention as set forth in the following claims.

What is claimed:

1. A method of making a musical instrument, comprising:
providing a body;
disposing a shoulder pin in a cavity of the body;
disposing a neck in the cavity of the body and around the shoulder pin; and
disposing a bolt through the body and into an opening on the neck.

2. The method of claim 1, further including disposing a neck plate on the neck and attaching the bolt to the neck plate.

3. The method of claim 2, further including forming a reinforcing ridge on a surface of the neck plate.

4. The method of claim 2, further including disposing the neck plate recessed relative to a surface of the neck.

5. The method of claim 1, further including:
disposing a rear plate in a recess of the body; and
disposing the bolt through the rear plate.

6. The method of claim 1, further including attaching the shoulder pin in the cavity of the body with a press fit.

7. A method of making a musical instrument, comprising:
providing a body;
disposing a pin in a cavity of the body; and
disposing a neck in the cavity of the body and around the pin.

8. The method of claim 7, further including:
disposing a bolt through the body; and
attaching the bolt to the neck.

9. The method of claim 8, further including:
disposing a rear plate in a recess of the body; and
disposing the bolt through the rear plate.

10. The method of claim 9, wherein a surface of the rear plate is coplanar with a surface of the body.

11. The method of claim 7, further including:
disposing a neck plate on the neck; and
disposing the pin through the neck plate.

12. The method of claim 11, further including forming a reinforcing ridge on a surface of the neck plate.

13. The method of claim 7, further including attaching the pin in the cavity of the body with a press fit.

14. A musical instrument, comprising:
a body;
a neck;
a first pin disposed in a first recess of the body and a second recess of the neck; and
a bolt disposed through the body and attached to the neck.

15. The musical instrument of claim 14, further including a neck plate attached to the neck around the first pin.

16. The musical instrument of claim 15, wherein a top surface of the neck plate is recessed relative to a surface of the neck.

17. The musical instrument of claim 14, wherein no fasteners other than the bolt are disposed through the body to attach the neck to the body.

18. The musical instrument of claim 14, further including a rear plate disposed between the body and a head of the bolt.

19. The musical instrument of claim 14, wherein the first pin is press fit into the body.

20. The musical instrument of claim 14, further including a second pin disposed in a third recess of the body and a fourth recess of the neck.

21. A musical instrument, comprising:
a body;
a neck; and
a first pin disposed between the neck and body.

22. The musical instrument of claim 21, further including only a single bolt disposed through the body and attached to the neck.

23. The musical instrument of claim 22, further including a neck plate attached to the neck, wherein the bolt is attached to the neck through the neck plate.

24. The musical instrument of claim 21, further including a second pin disposed between the neck and body.

25. The musical instrument of claim 21, wherein the first pin is press fit into the body.
